(19) United States
(12) Patent Application Publication
(10) Pub. No.: US 2011/0095149 A1
(43) Pub. Date: Apr. 28, 2011

(54) MULTI-LAYERED STRUCTURE FOR SUCTION DISC

(76) Inventor: Eagle Fan, Hsinchu (TW)

(21) Appl. No.: 12/604,603

(22) Filed: Oct. 23, 2009

(51) Int. Cl. F16B 47/00

(52) U.S. Cl. 248/206.2

(57) ABSTRACT

A multi-layered structure for suction disc is provided, including a disc element unit and a wrapping unit. The disc element unit has a shape of disc and is made of soft material. The bottom of the disc element unit us wrapped by the wrapping unit. The material of wrapping unit is even softer than the disc element unit. The suction disc bottom of the present invention is the soft surface of the wrapping unit so that the wrapping unit can tightly attach to the contact surface when in use.

### FIELD OF THE INVENTION

The present invention generally relates to a suction disc, and more specifically to a structure for suction disc with a soft wrapping unit to enhance the suction effect.

### BACKGROUND OF THE INVENTION

The suction of a suction disc is to press a suction disc against the contact surface, and then use external force to pull the central area of the suction disc away from the contact surface. During the process, the space between the central area of the suction disc and the contact surface will increase and generates a vacuum-like suction to attach the suction disc to the contact surface. The restriction when using this type of suction disc is that the contact surface must be smooth, such as, glass, ceramic tiles, smooth desk top, and so on. If the contact surface is not smooth, the edge of the suction disc cannot completely seal in the air with the contact surface, the vacuum like suction force cannot be generated.

At present, the top surface above the dash board is usually non-smooth, such as, leather texture, with tiny patterns. The conventional suction disc cannot be used to attach to this type of top surface. Instead, the suction disc often attached to the windshield, which is a practice banned in some countries. This is because this type of suction disc is used by device holder to hold portable electronic devices. With the portable electronic device holder attached to the windshield, the device may obstruct the sight of the driver and leading to dangerous driving. It is, therefore, imperative to devise a suction disc that can be adhere to the non-smooth top surface above the dash board so that the portable electronic device holder can be used in vehicles.

### SUMMARY OF THE INVENTION

The primary object of the present invention is to provide a multi-layered structure for suction disc suitable for various applications. The suction disc of the present invention is not limited to smooth surface only, but can also be used with flat and near smooth surface so that the suction disc can be used more widely.

Another object of the present invention is to provide a multi-layered structure for suction disc that is easy to manufacture. Although the present invention provides a multi-layered structure for the suction disc, the fabrication can be easily accomplished through a multiple runs of injection molding. In addition, because of the special design, the interconnection among the elements of the structure is strong and not prone to break.

To achieve the above objects, the present invention provides a disc element unit and a wrapping unit. The disc element unit has a shape of disc and is made of soft material. The bottom of the disc element unit us wrapped by the wrapping unit. The material of wrapping unit is even softer than the disc element unit. The suction disc bottom of the present invention is the soft surface of the wrapping unit so that the wrapping unit can tightly attach to the contact surface when in use.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the first embodiment of the invention;

FIG. 2 shows a top view of the structure shown in FIG. 1;

FIG. 3 shows an AA cross-sectional view of FIG. 2;

FIG. 4 shows a schematic view of the present invention in actual application;

FIG. 5 shows a schematic view of the disc element unit of the first embodiment of the present invention;

FIG. 6 shows a BB cross-sectional view of FIG. 2;

FIG. 7 shows a schematic view of the second embodiment of the present invention; and

FIG. 8 shows a cross-sectional vie of the third embodiment of the present invention.

### DETAILED DESCRIPTION OF THE PREFERRED EMBODIMENTS

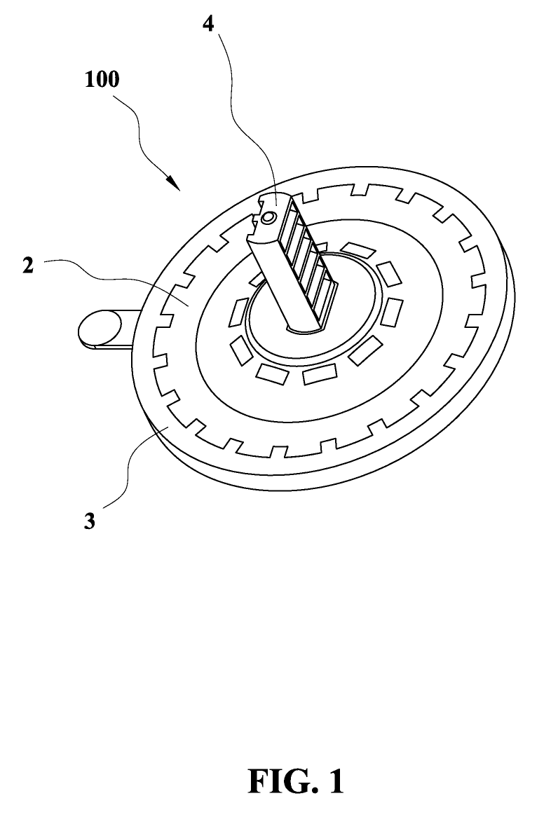

FIG. 1 shows a schematic view of the multi-layered structure for suction disc according to the invention. As shown in FIG. 1, suction disc 100 includes a disc element unit 2, a wrapping unit 3 and a link element 4. Link element 4 is engaged to the center part of the top surface of disc element unit 2. The bottom of disc element unit 2 is wrapped by wrapping unit 3. When suction disc 100 is in use, another component is used to pull link element 4 so that a vacuum-like attraction force is generated between the center area at the bottom of suction disc and the contact surface. The shape of link element 4 of the present invention is not limited to any specific shape. Link element 4 is a conventional element with a shape suitable for the shape of the suction disc.

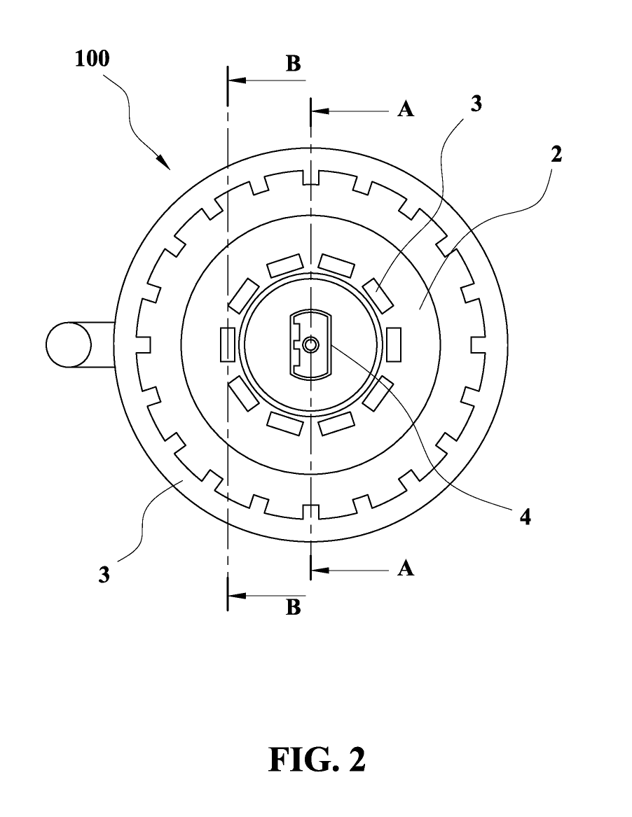

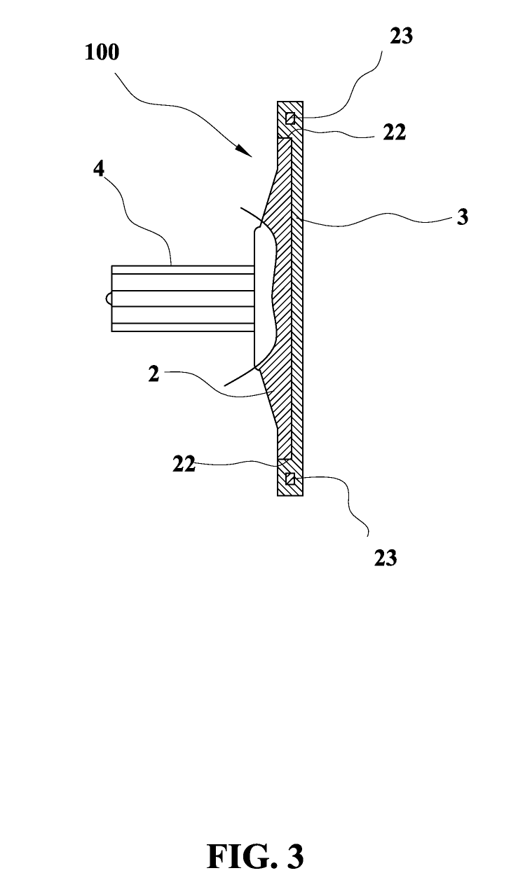

FIG. 2 and FIG. 3 show a top view and a cross-sectional view of the present invention respectively. The feature of the present invention is to replace the original single layered structure of the suction disc with the two-layered structure suction disc 100. The main part of suction disc 100 includes disc element unit 2 and wrapping unit 3. Disc element unit 2 has the shape of a disc, and is made of soft rubber/plastic material, with suitable hardness, and yet able to bend. Wrapping unit 3 wraps the bottom of disc element unit 2. The material of wrapping unit 3 is even softer than disc element unit 2. Suction disc 100 is fabricated with a multi-round injection molding so that are components are tightly engaged with each other. For example, the first round of injection molding is to form link element 4. Then, disc element unit 2 is formed close to the bottom of link element 4. Finally, the bottom of disc element unit 2 is wrapped by forming wrapping unit 3 through injection molding. In this manner, the bottom (contact surface) of suction disc 100 is a soft surface formed by wrapping unit 3.

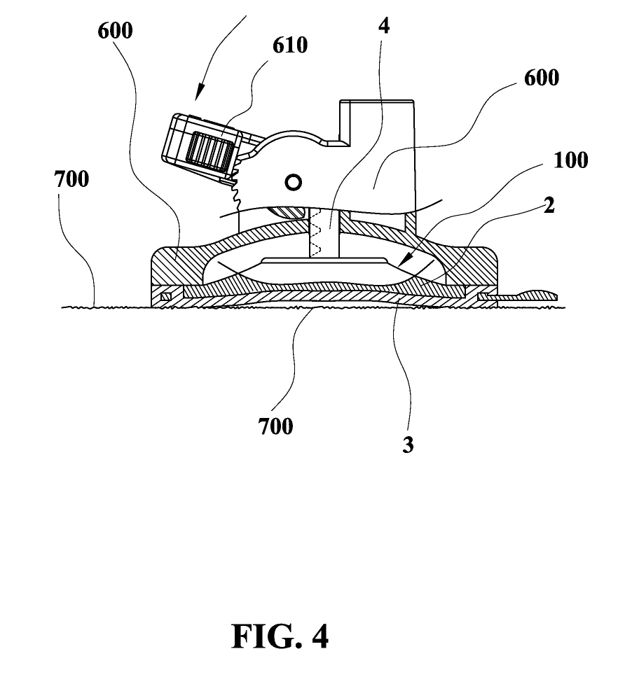

FIG. 4 shows a schematic view of the present invention in actual application. Suction disc 100 is installed at a holder 600. With wrench element 610 an internal linkage structure of holder 600, holder 600 can pull link element 4 of suction disc upwards so that suction disc is attached to contact surface by the vacuum-like suction force. The linkage and movement manner of suction disc 100 is similar to the conventional suction disc, and thus is omitted here. As shown in FIG. 4, the main feature of the present invention is that when suction disc 100 is placed on a non-smooth contact surface 700, such as faux leather, or slightly coarse plastic surface, wrapping unit 3 can fill the tiny gaps on the coarse surface with the soft material to achieve the tightly coupling. When an external force is exerted on link element 4 of suction disc 100 to pull upwards, the central area of disc element unit 2 (along with wrapping unit) will be also pulled upwards to slightly disengage from contact surface 700. However, as the edges disc element unit 2 and wrapping unit 3 are still tightly attached to contact surface 700, a vacuum-like suction force is generated to maintain the attachment. In this manner, the soft material filling the tiny gaps on a coarse contact surface 700 allows the present invention to be used on such surfaces while maintaining strong suction hold.

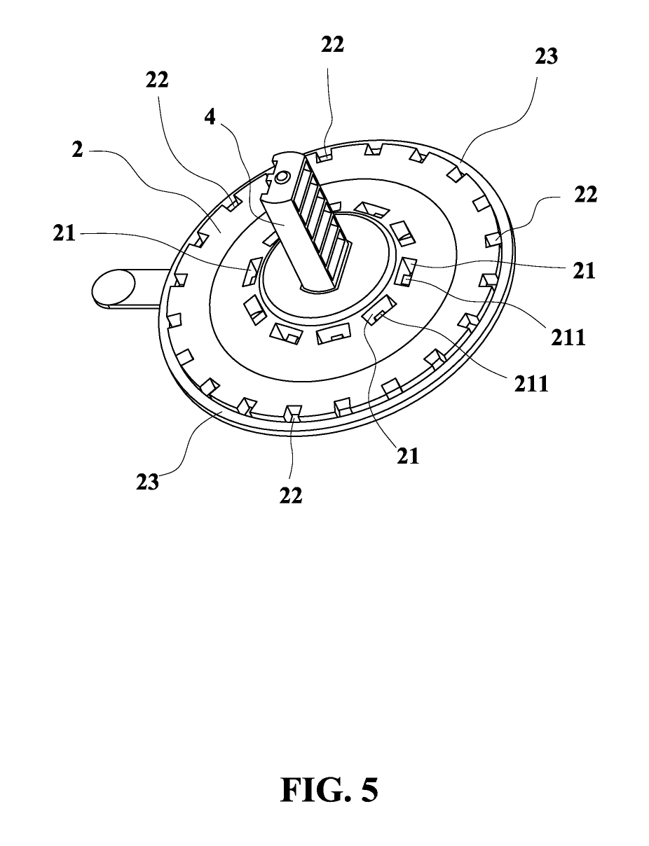

Furthermore, when suction disc 100 is in use, wrapping unit 3 and disc element unit 2 are tightly engaged. The present invention provides a plurality of design embodiments to achieve such tight engagement so that wrapping unit 3 is durable and will not be disengage from disc element unit 2. FIG. 5 shows a schematic view of disc element unit 2. In this embodiment, disc element unit 2 has the shape of a circular disc, with a plurality of first engaging holes 21 and second engaging holes 22. First engaging holes 21 are evenly distributed surrounding the area close to the center on disc element unit 2, and second engaging holes 22 are evenly distributed surrounding the area close to the edge on disc element unit 2. Each first engaging hole 21 includes at least a rib 211 inside. The two ends of rib 211 are engaged to the inner wall of first engaging hole 21 so that rib 211 horizontally crosses first engaging hole 21. Because the width of rib 211 is smaller than the diameter of first engaging hole 21, gaps are formed between rib 211 and inner wall of first engaging hole 21. Also, rib 211 is located close to the lower exit of first engaging hole 21. The edge of disc element unit 2 include a ring edge 23, right next to second engaging holes 22, with thickness thinner than the other part of disc element unit 2.

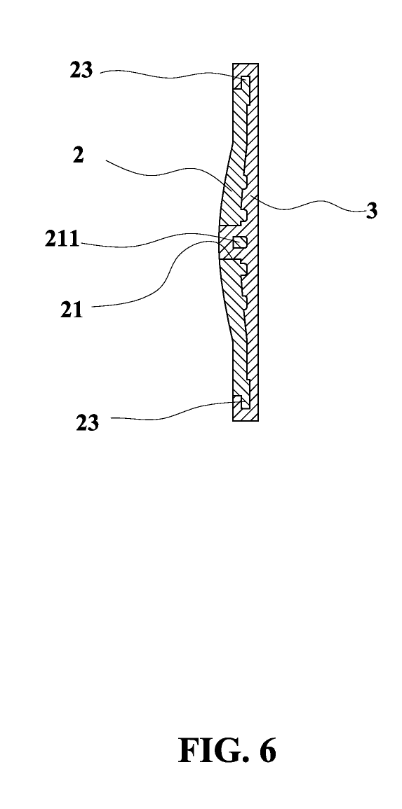

FIG. 3 and FIG. 6 show an AA cross-sectional view and a BB cross-section view of FIG. 2 respectively. When wrapping unit 3 wraps around disc element unit 2, the material for fabricating wrapping unit 3 will also fill first engaging holes 21 and second engaging holes 22 of disc element unit 2, and wrapping unit 3 completely wraps ring edge 23. As shown in FIG. 3, as the material of wrapping unit 3 completely wraps second engaging holes 22 and ring edge 23, wrapping unit 3 will not disengage from disc element unit 2. As shown in FIG. 6, the material of wrapping unit 3 completely wraps first engaging holes 21 and inside ribs 211, wrapping unit 3 will not disengage from disc element unit 2. In this manner, wrapping unit 3 and disc element unit 2 are tightly engaged to each other.

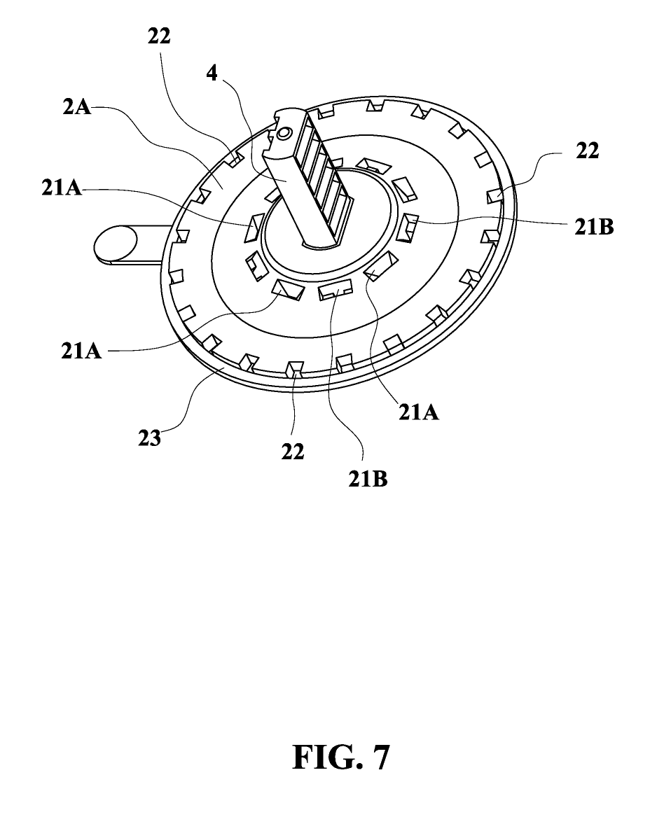

FIG. 7 shows a schematic view of the second embodiment of the present invention. As shown in FIG. 7, the present embodiment enhances the shape of the first engaging holes of disc element unit 2A. Although first engaging holes 21A, 21B still penetrate disc element unit 2A, the shape is different from the first embodiment. In the present embodiment, the diameter of first engaging holes 21A, 21B close to the bottom of disc element unit 2 is smaller than the diameter of first engaging holes 21A, 21B close to the top of disc element unit 2. As shown in FIG. 7, disc element unit 2A includes a plurality of first engaging holes 21A and a plurality of first engaging holes 21B. First engaging holes 21A and 21B are still evenly distributed surrounding the area close to the center of disc element unit 2A. The diameter of first engaging holes 21A forms a cone shape with a wider top. The diameter of first engaging holes 21B is a two-step form. The diameter of the top half is larger than the diameter of the lower half of first engaging holes 21B. In this manner, the material forming wrapping unit 3 fills first engaging holes 21A, 21B when wrapping around disc element unit 2 to form a hook-like engagement to achieve stronger hold between disc element unit 2 and wrapping unit 3. In addition, the design of the second engaging holes can be similar to the design of the first engaging holes of the present embodiment, that is, the diameter of second engaging holes close to the bottom of disc element unit 2 is smaller than the diameter of second engaging holes close to the top of disc element unit 2. In other words, the shapes of first engaging holes and the second engaging holes of the present invention are not restricted to any specific shapes.

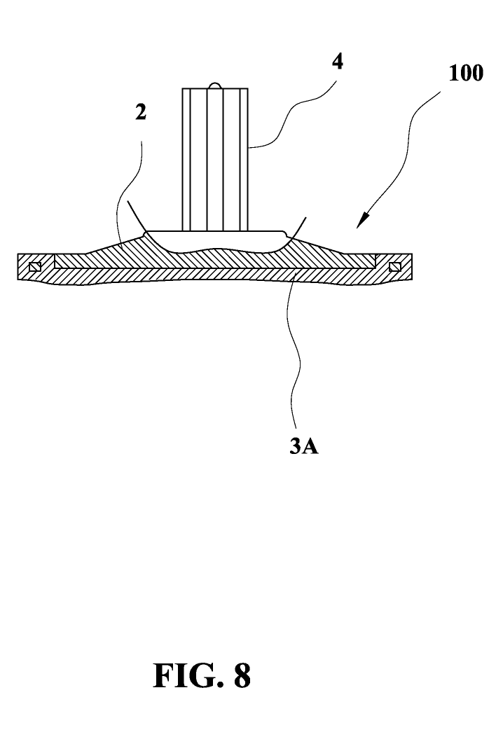

FIG. 8 shows a schematic view of the third embodiment of the present invention. The previous embodiments have flat surface formed by the wrapping unit as the bottom of the suction disc. In the present embodiment, the bottom formed by wrapping unit 3A is a slightly arc surface. Take the thickness of wrapping unit 3A beneath of disc element unit 2 as an example for description. Wrapping unit 3 is thickest at the area close to the edge of disc element unit 2, and is thinner at the edge and the area close to the center of disc element unit 2. The thickest area of wrapping unit 3 is the area to tightly suck on the contact surface when suction disc 100 is in use.

In summary, the multi-layered structure for suction disc of the present invention provides a two-layered structure with the upper layer as disc element unit made of rubber, and the lower layer as wrapping unit made of a softer rubber/plastic material so that the present invention is applicable to non-smooth contact surface while maintaining strong suction force to achieve strong hold.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A multi-layered structure for suction disc, comprising:
a disc element unit, being shaped as a circular disc and being made of soft material; and
a wrapping unit, wrapping around said disc element unit, made of a material softer than said disc element unit;
wherein bottom of said suction disc being a soft surface formed by said wrapping unit.

2. The multi-layered structure for suction disc as claimed in claim 1, wherein area close to center of said disc element unit comprises a plurality of first engaging holes, and when material forming said wrapping unit fills said first engaging holes when wrapping around said disc element unit.

3. The multi-layered structure for suction disc as claimed in claim 2, wherein said first engaging holes are evenly distributed surrounding area close to center of disc element unit in a ring manner.

4. The multi-layered structure for suction disc as claimed in claim 2, wherein each said first engaging hole comprises at least a rib inside, said rib is smaller than diameter of said first engaging hole so that said material forming said wrapping unit fills said first engaging holes and wraps around said rib when wrapping around said disc element unit.

5. The multi-layered structure for suction disc as claimed in claim 2, wherein diameter of said first engaging holes close to bottom of said disc element unit is smaller than diameter of said first engaging holes close to top of said disc element unit.

6. The multi-layered structure for suction disc as claimed in claim 1, wherein area close to edge of said disc element unit comprises a plurality of second engaging holes, and when material forming said wrapping unit fills said second engaging holes when wrapping around said disc element unit.

7. The multi-layered structure for suction disc as claimed in claim 6, wherein said second engaging holes are evenly distributed surround area close to edge of disc element unit in a ring manner.

8. The multi-layered structure for suction disc as claimed in claim 6, wherein edge of said disc element unit comprises a ring edge, right next to said second engaging holes, with thickness thinner than other part of said disc element unit, and said material forming said wrapping unit also wraps around said ring edge through said second engaging holes.

9. The multi-layered structure for suction disc as claimed in claim 1, diameter of said second engaging holes close to bottom of said disc element unit is smaller than diameter of said second engaging holes close to top of said disc element unit.
